(19) United States
(12) Patent Application Publication
(10) Pub. No.: US 2026/0050617 A1
(43) Pub. Date: Feb. 19, 2026

(54) SYSTEMS AND METHODS FOR GROUNDED QUERY GENERATION OVER HETEROGENEOUS DATA SOURCES

(71) Applicant: ACCENTURE GLOBAL SOLUTIONS LIMITED, Dublin (IE)

(72) Inventors: Nimrod BUSANY, Tel Aviv (IL); Gil ROSENBLUM, Tel Aviv (IL); Hananel HADAD, Givat Shmuel (IL); Eitan HADAR, Nesher (IL); Nir YARDEN, Jerusalem (IL); Dan KLEIN, Rosh Ha’ayin (IL)

(73) Assignee: ACCENTURE GLOBAL SOLUTIONS LIMITED, Dublin (IE)

(21) Appl. No.: 19/300,327

(22) Filed: Aug. 14, 2025

Related U.S. Application Data
(60) Provisional application No. 63/684,123, filed on Aug. 16, 2024.

(51) Int. Cl. G06F 16/3329; G06F 16/383

(52) U.S. Cl. CPC G06F 16/3329; G06F 16/383

(57) ABSTRACT

Disclosed is a system and method for grounded query generation over heterogeneous data sources. The method includes receiving a user input corresponding to a user requirement from at least one user, extracting a plurality of sub-models corresponding to the received user input, creating a context of the received user input based on the extracted plurality of sub-models, generating an executable query in a specific query language based on the context using a Large Language Model (LLM) by processing the context and the user input within a structured prompt, validating the generated executable query using a multi-stage validation process, generating an LLM response for the received user input based on results of the validation, and outputting the generated LLM response on a user interface of a user device.

### CROSS-REFERENCE TO RELATED PATENT APPLICATIONS

This application claims priority to U.S. Provisional Application No. 63/684,123, filed on Aug. 16, 2024, the entire content of which is hereby incorporated by reference in the entirety for all purposes.

### TECHNICAL FIELD

The present disclosure generally relates to the field of large language models and, more particularly, to systems and methods for grounded query generation over heterogeneous data sources.

### BACKGROUND

When organizations seek to answer key questions using data, the process typically involves two main stages of data discovery and query generation. The data discovery stage includes identifying and locating the relevant data from internal systems or external sources. The query generation stage includes writing executable, machine-readable queries to extract desired information from the data.

In recent years, organizations have significantly expanded the volume of data they collect, generate, and acquire. The organizations are also shifting from traditional, centralized data architectures (like data warehouses and data lakes) toward more decentralized models, such as data meshes. This shift has resulted in data becoming more scattered, less structured, and increasingly heterogeneous across various systems. As organizations adopt decentralized data architectures and collect increasingly diverse datasets, the process of locating relevant data and generating executable queries has become more difficult. The heterogeneity of storage systems and query languages creates a significant barrier to efficient data analysis, especially when data must be retrieved and integrated across multiple platforms.

For example, the stages of finding the right data and writing the appropriate queries have become more complex and time-consuming. The heterogeneity of data also introduced technical challenges, for example, different systems require different query languages. For instance, retrieving data from relational databases use Structured Query language (SQL), while retrieving data from a graph database may require languages like Cypher or SPARQL. This variety in query languages adds further complexity to the data retrieval and analysis process.

### SUMMARY

This summary is provided to introduce a selection of concepts in a simple manner that is further described in the detailed description of the disclosure. This summary is not intended to identify key or essential inventive concepts of the subject matter, nor is it intended for determining the scope of the disclosure.

Systems and methods for grounded query generation over heterogeneous data sources are disclosed. The method includes receiving a user input corresponding to a user requirement from at least one user, wherein the user input includes at least one entity and at least one concept corresponding to the user requirement, extracting a plurality of sub-models corresponding to the received user input based on a semantic similarity between the user input and a plurality of ontological representations of data sources stored in a semantic data catalog, and creating a context of the received user input based on the extracted plurality of sub-models, wherein the context includes a subgraph representing linked entities and relationships semantically related to the user input. The method further includes generating an executable query in a specific query language based on the context using a Large Language Model (LLM) by processing the context and the user input within a structured prompt, wherein the context is represented in a query-language-specific schema format, validating the generated executable query using a multi-stage validation process, wherein the multi-stage validation process includes at least one of a syntax validation, a benign operation check, a grounding validation, and an execution validation, generating an LLM response for the received user input based on results of the validation, wherein the LLM response includes an explanation corresponding to the generated executable query and the generated executable query, and outputting the generated LLM response on a user interface of a user device.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 depicts an example environment including a system for assessing and improving data interoperability of large language models, in accordance with an embodiment of the present disclosure;

FIG. 2 depicts a block diagram of the system, in accordance with an embodiment of the present disclosure;

FIG. 3 is a flowchart illustrating a method for grounded query generation over heterogeneous data sources, in accordance with an embodiment of the present disclosure; and

FIG. 4 illustrates a computer system that may be used to implement the system disclosed in the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/act involved.

Specific details are provided in the following description to provide a thorough understanding of embodiments. However, it will be understood by one of the ordinary skills in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

To address the one or more limitations described in the background, embodiments of the present disclosure describe systems and methods for grounded query generation over heterogeneous data sources. That is, the system is configured to generate one or more queries over heterogeneous data sources for retrieving data relevant to a user input (a user query). Initially, upon receiving a user input corresponding to a user requirement, the system extracts a plurality of sub-models corresponding to the received user input based on a semantic similarity between the user input and a plurality of ontological representations of data sources stored in a semantic data catalog. Then the system creates a context for the received user input based on the extracted plurality of sub-models, wherein the context includes a subgraph representing linked entities and relationships semantically related to the user input. Upon creating the context, the system generates an executable query in a specific query language based on the context using a Large Language Model (LLM). by processing the context and the user input within a structured prompt, wherein the context is represented in a query-language-specific schema format. Then the system validates the generated executable query by using one or more of a syntax validation, a benign operation check, a grounding validation, and an execution validation and generates an LLM response for the received user input based on results of the validation. The generated response is then presented to the user through an interface of the user device.

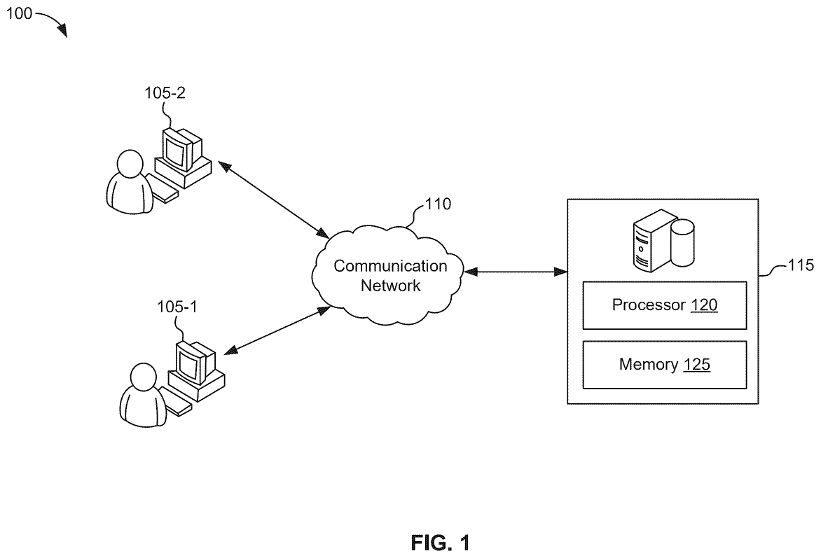

FIG. 1 depicts an example environment including a system for grounded query generation over heterogeneous data sources, in accordance with an embodiment of the present disclosure. As shown, the environment 100 environment 100 includes a plurality of user devices (shown only two data sources 105-1 and 105-2), a communication network 110 and a system 115, wherein the plurality of user devices 105 and the system 115 are communicatively connected over the communication network 110.

The user device 105 may include a desktop, a server, and a combination of servers. The user devices 105 may present one or more user interfaces (e.g., Graphical User Interfaces (GUIs)) of a workspace for the user to interact with the system 115. The user devices 105 may be used to provide input and/or receive output to/from the system 115. The input or the input data may include a user input corresponding to a user requirement in a natural language. An example, natural language input may include at least one entity and at least one concept corresponding to the user requirement.

In some examples, the communication network 110 includes a Local Area Network (LAN), a Wide Area Network (WAN), the Internet, or a combination thereof, and connects plurality of user devices 105 and the system 115. In some examples, the communication network 110 may be accessed over a wired and/or a wireless communication link. For example, a computing device like smartphone may utilize a cellular network to access the communication network 110.

In one embodiment, the system 115 may be implemented as an on-premises system that is operated by an enterprise or a third-party engaged in cross-platform interactions and data management. In some examples, the system 115 may be implemented as an off-premises system (for example, cloud or on-demand) that is operated by an enterprise or a third-party on behalf of an enterprise. In some examples, the system 115 may be implemented in a cloud environment. For simplicity, the system 115 depicted in FIG. 1 may be a cloud environment that is intended to represent various forms of servers including a web server, an application server, a proxy server, a network server, a server pool, and/or the like.

In some examples, the system 115 may be implemented by way of a single device or a combination of multiple devices that may be operatively connected or networked together. The system 115 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications. Referring to FIG. 1, the system 115 includes a processor 120 and a memory 125 communicably coupled to the processor 120. The processor 120 may include one or more processors. Examples of the processor 120 may include, but are not limited to, microprocessors, microcomputers, microcontrollers, digital signal processors, central processing units, state machines, logic circuits, and/or any devices that manipulate data or signals based on operational instructions. Among other capabilities, the processor 120 may fetch instructions (also be referenced to as processor-executable instructions or machine-executable instructions) from the memory 125 and execute the fetched instructions for performing operations according to the present disclosure. The memory 125 may be non-volatile or non-transitory computer-readable medium (CRM) such as, a magnetic disk or solid-state non-volatile memory or volatile medium such as Random Access Memory (RAM), and/or the like.

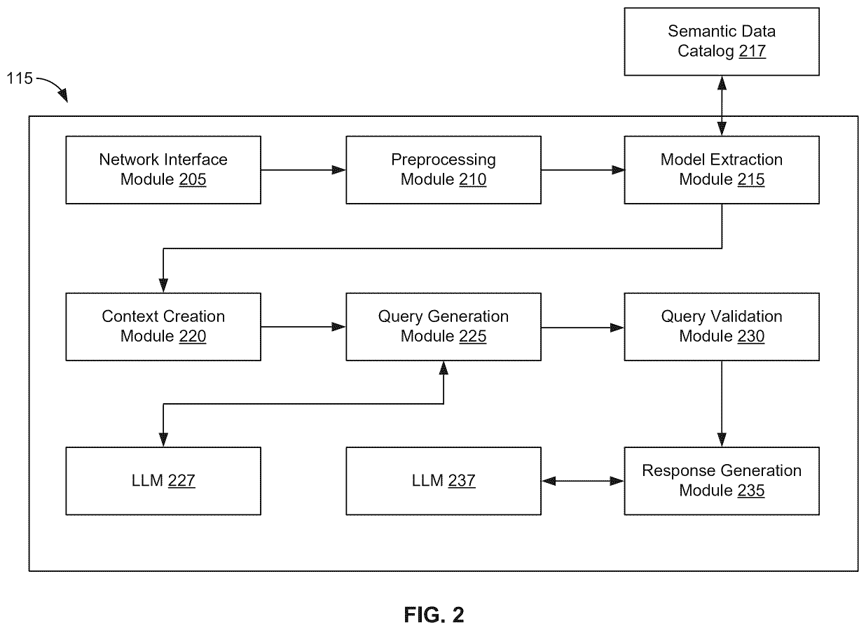

FIG. 2 depicts a block diagram of the system, in accordance with an embodiment of the present disclosure. As shown, in addition to the processor 120 and the memory 125, the system 115 includes a network interface module 205 enabling communication between the system 115 and the plurality of user devices 105, a preprocessing module 210, a model extraction module 215, a context creation module 220, a query generation module 225, a query validation module 230, a response generation module 235 and a Large Language Module (LLM) 237. It should be noted that the LLM 240 may either be part of the system 115, as shown, or external to the system 115.

In one embodiment of the present disclosure, the system 115 is configured for grounded query generation over heterogeneous data sources based on a user requirement, that is based on the user input. For example, a user may input a natural language query to the system 115 using the user device 105 associated with the user. The user input includes requirement having at least one entity and at least one concept corresponding to the user requirement. For example, the user input may include text or spoken requests on what the user needs or expects from the system 115. Accordingly, the object may include a specific object, person, place, or thing related to the domain such as customer, invoice, order, etc., and the concept may include an action the user is referring to, for example generate data, fetch and summarize information related to an object or a person, etc.

Upon receiving the user input, the preprocessing module 210 preprocesses the user input using a natural language processing model, wherein the natural language processing model includes sub-modules such as a named entity recognition (NER), a part-of-speech (POS) tagging, a dependency parsing, and a domain-specific concept mapping to extract structured meaning of the user input. For example, NER is used to identify specific named entities in the input, POS tagging is used to label each word with the grammatical role, dependency parsing is used to analyze the grammatical structure and link words based on syntactic relationships, and domain-specific concept mapping is used to map user terms to known concepts in a specific business domain. Hence, the preprocessing module 210 extracts the entities and their roles, understands the grammatical relationships and maps extracted elements to domain-specific business logic to convert the user input into actionable data for further processing.

In an embodiment of the present disclosure, upon preprocessing, the model extraction module 215 uses the preprocessed user input to extract a plurality of sub-models corresponding to the received user input. In an embodiment, the model extraction module 215 extracts the plurality of sub-models from a semantic data catalog 212 based on a semantic similarity between the user input and a plurality of ontological representations of data sources stored in the semantic data catalog 212. It should be noted that the ontological representations of data sources are pre-formed and stored in the semantic data catalog 212. The ontological representations for one or more data sources are created by crawling the repositories, finding specifications, and extracting object definitions. Then a representation of all objects found in the specifications are created and the representation is refined according to pre-configured object classification and refinement procedures. Then formal ontological representations are created that reflect the conceptual model behind the service. The way in which the ontological representations of the data sources are created is disclosed in US patent application “18/070,764”, titled “Generating ontologies from programmatic specifications” filed on “Nov. 29, 2022”, the disclosure of which is incorporated herein by reference in its entirety.

As described, the model extraction module 215 extracts the plurality of sub-models corresponding to the received user input based on the semantic similarity between the user input and the plurality of ontological representations of data sources stored in the semantic data catalog. In an embodiment, the model extraction module 215 initially encodes the preprocessed user input into a first vector embedding using a sentence and cross-encoder language model trained to generate contextualized semantic embeddings. The sentence encoder, based a transformer architecture like Bidirectional Encoder Representations from Transformers (BERT) or ROBERTa, is finetuned to produce semantic vector embeddings and this encoder takes a single sentence as input and returns a numerical vector (for example, 384 or 768 values), representing the meaning of the sentence in context. Further, the vectors are contextualized by considering the surrounding words when determining what each word means. In an embodiment, the cross-encoder processes two inputs together to produce the semantic vector embeddings. The embeddings are then stored in the memory associated with the system 115 for further processing.

Further, the model extraction module 215 retrieves the plurality of ontological representations from the semantic data catalog 217, wherein each ontological representation corresponds to a type of data source of the organization and wherein each ontological representation being modeled as an ontology includes classes, data properties, object properties, and individuals. That is, the model extraction module 215 queries the semantic catalog 217 using SPARQL or other semantic query languages and requests all ontologies corresponding to different data sources of the organization to retrieve the ontological models having classes, data properties, object properties and individuals.

Then the model extraction module 215 generates a plurality of vector embeddings for each ontological component within the plurality of ontological representations using a pretrained language model. That is, for each component (for example, class, property, individual) in multiple ontologies, the model extraction module 215 generates semantic vector embeddings using the pretrained language model. The embeddings enable machines to understand the meaning and relationships between concepts in a quantitative way and further enable semantic similarity, clustering and reasoning. For example, ontology having classes, properties and individuals, is fed to the pretrained model BERT or Sentence-BERT which are pretrained to embed text into a high-dimensional vector space. This produces a plurality of vector embeddings for each ontological component.

Upon generating the first vector embeddings for the user input and a plurality of vector embeddings for each ontological component, the model extraction module 215 computes semantic similarity scores between the first vector embedding of the user input and each of the plurality of vector embeddings associated with the ontological components using a cosine similarity function. The cosine similarity measures the cosine of the angle between two vectors in a high-dimensional space.

$$cosine\_similarity ( \vec{u} , \vec{v} ) = \frac{\vec{u} . \vec{v}}{‖ \vec{u} ‖ ‖ \vec{v} ‖} \qquad Eq . ( 1 )$$

Wherein,
\vec{u} is first vector embeddings for the user input
\vec{v} is one of the ontological component vector embeddings
∥\vec{u}∥ is the Euclidian norm (magnitude) of vector \vec{v}

Using the above equation (1), the model extraction module 215 scores the ontological concepts and ranks to evaluate which ontological concepts are most semantically similar to the user input.

Further, from a plurality of ontologies (or one ontology with multiple conceptual domains), the model extraction module 215 identifies relevant subgraphs based on semantic similarity to the user input. In an embodiment of the present disclosure, a threshold is defined (for example T=0.75) and the ontological components of which the cosine similarity score is greater than the predefined threshold are selected. Each ontological component belongs to a graph representing a sub-ontology or sub-domain. In an embodiment, the model extraction module 215 extracts subgraphs that include semantically matched concepts, directly connected neighbors and original or inferred relationships (edges). Further, the model extraction module 215 extracts the semantic coherence of each subgraph by finding intermediate or linking nodes and properties that connect the selected components. Then the model extraction module 215 generates a plurality of sub-models as sub-graphs by combining semantically similar components and their meaningful linking relations.

As described, the model extraction module 215 extracts the plurality of sub-models using the semantic data catalog and by computing sematic similarity between the user input and the ontological components.

Upon extracting the plurality of sub-models, the context creation module 220 creates a context of the received user input based on the extracted plurality of sub-models, wherein the context includes a subgraph representing linked entities and relationships semantically related to the user input. In an embodiment, to create the context, the context creation module 220 initially aggregates the extracted plurality of sub-models, wherein each sub-model includes a subset of ontological components selected from ontologies stored in the semantic data catalog, and wherein the ontological components include at least one of classes, data properties, object properties, and individuals. As described, each sub-model is a subgraph extracted from the ontology and includes classes, data properties, object properties, and individuals. In an embodiment, all the sub-models are aggregated into a temporary union graph. This includes potentially overlapping entities and duplicated relationships. Then the context creation module 220 generates a unified intermediate graph structure as a preliminary context graph, wherein the extracted plurality of sub-models being preprocessed to filter duplicate entities and overlapping object properties across the sub-models using canonical entity alignment and ontology normalization rules. That is, the context creation module 220 creates a deduplicated, normalized, and structurally unified version of the aggregated sub-models by using methods such as canonical entity alignment (by identifying equivalent entities across sub-models using equivalence rules or semantic similarity), ontology normalization rules to ensure consistent representation of classes, properties, and individuals.

Furthermore, the context creation module 220 identifies missing linking entities and missing relationships from the ontologies to be embedded in the plurality of sub-models. The missing linking entities and the missing relationships determined to be required for forming connected paths between the at least one entity and the at least one concept in the preliminary context graph. That is, the context creation module 220 detects gaps to ensure a cohesive semantic path exists between relevant concepts and entities. The context creation module 220 identifies disconnected or weakly connected pair of nodes in the graph and identifies intermediate nodes or object properties from the source ontologies to bridge the gaps by considering graph distance, relationship strength and domain relevance. Then the context creation module 215 updates the identified missing linking entities and relationships into the graph by traversing the original ontology and inserting semantically valid paths. Further, the context creation module 220 performs a graph completeness check to validate reachability of each of the at least one entity and the at least one concept from the user input within the updated preliminary context graph via ontologically valid object properties. The module 220 checks if all target concepts and instances derived from the input are connected through a sequence of object properties and relationships that are valid in the ontology. If any entity or concept is isolated, the module 220 re-initiates linking via ontology traversal or discard if not semantically related. Hence, the context extraction module 220 ensures that every semantically significant node (the node derived from the user input) is reachable via ontologically valid paths.

Further, the context creation module 220 filters semantically unrelated branches from the updated preliminary context graph based on a threshold semantic similarity score between each node and a user input embedding and construct a final context subgraph having semantically relevant entities, data properties, object properties, and linking paths representing a structure and relationships required to interpret the user input. That is, for each node in the graph, semantic similarity between the vector embeddings of the user input and embedding of the node label or description are computed. Further, the semantic similarity is compared with a predefined similarity threshold (for example 0.6) and the nodes having similarity scores less than the predefined thresholds are removed to ensure the graph remains focused and aligned with the input semantics. As described, the context creation module 220 creates the context of the received user input based on the extracted plurality of sub-models, wherein the context includes a subgraph representing linked entities and relationships semantically related to the user input.

In an embodiment, upon generating the context of the user input, the query generation module 225 generates an executable query in a specific query language based on the context using a Large Language Model (LLM) 227 by processing the context and the user input within a structured prompt, wherein the context is represented in a query-language-specific schema format. The query generation module 225 initially constructs a prompt by concatenating the received user input in natural language form, wherein the prompt includes a textual representation of the final context subgraph in the query-language-specific schema format, and a plurality of language-specific generation instructions. That is, the query generation module 225 takes the natural language user input and combines with context subgraph in a format required by the query language. The query language may be SQL, SPARQL, GraphQL, etc. Then the query generation module 220 adds instructions telling the LLM 225 on how to generate a query (for example, “Write a SQL query to answer the question”). Furthermore, the query generation module 225 converts the context subgraph into a format appropriate for the target query language (like SQL table definitions or SPARQL triples). Then the LLM 227 processes the natural language user input, the structured data schema and the instruction to generate one or more candidate executable queries in the specified query language.

In an embodiment, the processor 120 of the system 115 is configured to compute a semantic proximity score between the user input and entities within the context using a cross-encoder model trained on semantic similarity tasks, compare the computed semantic proximity score to a predefined threshold, update the plurality of sub-models with additional ontological entities semantically related to the user input, and regenerate the executable query using the updated the plurality of sub-models. This improves the quality and relevance of a generated query by computing semantic proximity between the user's input and available entities, expanding the context with semantically relevant ontological entities, and regenerating the query using this enriched context. To compute the semantic proximity score between the user input and the entities within the context, a cross-encoder model (e.g., a BERT-style model fine-tuned on sentence similarity tasks like STS) is used. Then the computed semantic proximity score is compared with a predefined threshold (for example 0.85) and retains entities having score above the predefined threshold. This filters out irrelevant or weakly related context elements. Then the sub-models with additional ontological entities semantically related to the user input and regenerate the executable query using the updated plurality of sub-models.

As described, the query generation module 225 creates a prompt which includes the user input, structured version of the context subgraph and the instructions for query generation. Then the module 225 feeds the prompt to the LLM 227 which generates multiple possible queries that may be executed against the data sources.

Upon generating the executable query, the query validation module 230 validates the generated executable query using a multi-stage validation process, wherein the multi-stage validation process includes at least one of a syntax validation, a benign operation check, a grounding validation, and an execution validation.

In an embodiment of the present disclosure, the query validation module 230 performs syntax validation using syntax parser model to check whether the generated query is syntactically correct in the target query language (like SQL, SPARQL, GraphQL, etc.). The syntax parser model analyses the query string, compares the query string against the formal grammar of the language, and detects the errors if any, the errors may include missing keywords, disordered classes, invalid identifiers or symbols, etc.

In another embodiment, the query validation module 230 performs the benign operation check by scanning the generated executable query for presence of potentially abnormal operations and reject queries having the potentially abnormal operations. This validation ensures safety and security by checking the generated query for potentially dangerous or abnormal operations, and rejecting any query that might perform unintended, harmful, or risky actions. The abnormal or risky operations may include modification or deletion of data, access of sensitive information, etc. Upon syntax validation, the query validation module 230 uses pattern matching, rule-based logic, or machine learning (ML) models to detect risky operations. If the query contains any blacklisted patterns or keywords, the query validation module 230 rejects the query or sends the query back for regeneration.

Furthermore, the query validation module 230 performs grounding validation by mapping tables, classes, columns, properties, and schema components present in the generated executable query with corresponding components in ontology-derived context subgraph. This validation is performed to ensure that everything referenced in the generated executable query (like table names, columns, classes, properties, etc.) exists in the ontology-derived context subgraph, that is, in the known schema or data model. In an embodiment, the query validation module 230 parses the query to extract tables/class names, column/property names, and relationships, and further parses the ontology driven sub-graph which includes class to table mapping, property names, and relationship between the entities. Then the module 225 compares each query component to schema, and rejects or corrects, if any components are not grounded in the schema, or there is any incomplete or ambiguous mapping.

Furthermore, the query validation module 230 performs an execution validation by executing the generated executable query in a staging environment to determine runtime errors. The staging environment is an isolated, production-like setup used for testing and mimics production in terms of data structure, scale, and permissions. The query validation module 230 uses the staging environment to run the executable query and monitors for syntax errors not caught at parse time, logical errors (for example, type mismatches, missing columns, invalid joints, resource constraints, and permission or access errors (for example, trying to read a restricted table), etc. Hence, the execution validation is performed to observe the actual behavior of the query during execution and to identify any errors that only surface during runtime.

Based on the results of the syntax validation, the benign operation check, the grounding validation, and the execution validation, the query validation module 230 generates one or more error messages corresponding to the generated executable query. Such error messages may be displayed on the user interface of the user device 105. Further, the query validation module 230 sends the error message back to the query generation module 225 which in turn updates the prompt to the LLM 227, wherein the updated prompt includes the user input, prior invalid query, and the error message. The system 115 iteratively generates the executable query until a predefined maximum retry limit is reached.

Upon generating a valid executable query, the query validation module 230 feeds the executable query to the response generation module 235. In an embodiment, the response generation module 235 generates a response for the received user input using the LLM 237, wherein the response includes an explanation corresponding to the generated executable query and the generated executable query and outputs the generated response for the received user input on the interface of the user device 105.

In an embodiment, upon receiving the executable query, the response generation module 235 generates a structured response which includes the validated executable query, and an explanation indicating a summary of operations being performed by the generated executable query, a mapping of each major clause in the generated executable query to a plurality of data entities, and a description of logical relationships between linked resources in the context subgraph. Further, the response generation module 235 determines a description of the ontological relationships and schema elements formed on basis of the context used for query generation. Then the response generation module 235 generates a response for the received user input using the LLM 237 and based on the generated structured response and the determined description of the ontological relationships and the schema elements. That is, upon receiving the validated executable query, the response generation module 235 generates a structured response (a machine-readable data object, for example, JSON) including the validated executable query, a summary of operation (a high-level explanation of what the query docs), and class to entity mapping, and a description of the logical relationships in the context subgraph. Further, the response generation module 235 analyzes the schema and context that were used to generate the query to determine ontological relationships between concepts/entities and schema elements. This provides semantic context to the query and ensures the LLM 237 understands the meaning behind data manipulations. Then the response generation module 235 feeds the structured response (validated executable query and semantic breakdown) and the ontological description and schema elements to the LLM 237 which uses both to produce human-readable context aware response. The generate response is displayed on the interface of the user device 105. In an embodiment, the LLM 237 fetches data and generates response using the data sources. Hence, the system 115 generates executable queries over heterogenous data sources, validates the generated queries, extracts structural and ontological metadata from queries and data schemas, and uses these to generate natural language responses that are accurate, grounded, and semantically rich.

As described in the present disclosure, using the sematic data catalog of the data sources of an organization, the system 115 automatically generates executable queries in any query language to answer the questions. That is, for a given user input in natural language form, the system 115 extracts sub-models, which have the highest semantic similarity to the user input. The system 115 then expands the extracted models to create a more complete context and feed the user input and the sub-model to a Large Language Model which is instructed to generate an executable query in a specific query language. Then the system validates the query to ensure that the model generated a valid response. Hence the system 115 generates executable queries (for example in SQL, SPARQL) for heterogenous and distributed information systems based on a natural language description of a question. That is, the system 115 is agnostic to the format of the data and can operate across various types of data sources including but are not limited to relational and non-relational databases, graph databases, Comma Separated Values (CSV), Parquet, JavaScript Object Notation (JSON), etc.

Furthermore, the system 115 validates and tests the correctness of the generated executable query and repeats the generation process if the validation fails. The system 115 also triggers and runs the generated queries to further validate the results. Furthermore, the system 115 enables the users to generate queries without being familiar with the organization's data sources and data architecture.

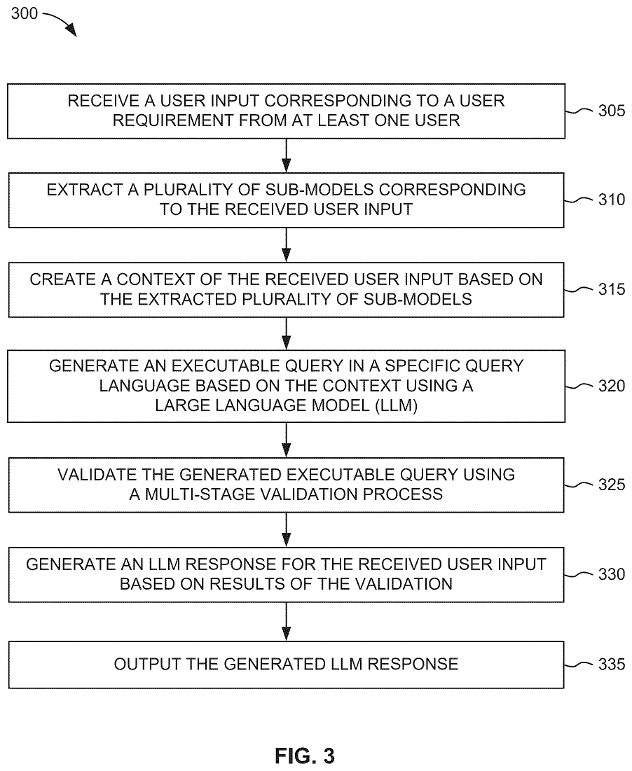

FIG. 3 is a flowchart illustrating a method for grounded query generation over heterogeneous data sources, in accordance with an embodiment of the present disclosure. As shown, at step 305, the system receives a user input corresponding to a user requirement from at least one user. The user input includes at least one entity and at least one concept corresponding to the user requirement. That is, the user input includes requirement having at least one entity and at least one concept corresponding to the user requirement. For example, the user input may include text or spoken requests on what the user needs or expects from the system 115. Accordingly, the object may include a specific object, person, place, or thing related to the domain such as customer, invoice, order, etc., and the concept may include an action the user is referring to, for example generate data, fetch and summarize information related to an object or a person, etc.

Upon receiving the user input, the system 115 extracts a plurality of sub-models corresponding to the received user input, as shown at step 310. It should be noted that the user input is preprocessed using a natural language processing model, wherein the natural language processing model includes sub-modules such as a named entity recognition (NER), a part-of-speech (POS) tagging, a dependency parsing, and a domain-specific concept mapping to extract structured meaning of the user input. Then the preprocessed user input is used to extract the sub-models. In an embodiment, the sub-modules are extracted based on a semantic similarity between the user input and a plurality of ontological representations of data sources stored in a semantic data catalog 217. Initially, the preprocessed user input is encoded into the first vector embedding using a sentence and cross-encoder language model trained to generate contextualized semantic embeddings. Then, the plurality of ontological representations is retrieved from the semantic data catalog and a plurality of vector embeddings are generated for each ontological components within the plurality of ontological representations using a pretrained language model. Further, semantic similarity scores between the first vector embedding of the user input and each of the plurality of vector embeddings associated with the ontological components are computed using a cosine similarity function and ranked. Then the system 115 selects a set of subgraphs corresponding to the plurality of sub-models from the plurality of ontological representations by mapping the semantic similarity scores with a predefined threshold value, identifies additional linking entities and properties in the ontology components to be embedded in each sub-model, and constructs one or more sub-models as the subgraph of an ontology comprising the semantically similar ontological components and corresponding linking relationships. The way in which the sub-models are extracted is described in detail with reference to model extraction module 215 of FIG. 2.

Then the system 115 creates a context of the received user input based on the extracted plurality of sub-models, as shown at step 315. In an embodiment, the context includes a subgraph representing linked entities and relationships semantically related to the user input. To create the context, the system 115 aggregates the extracted plurality of sub-models, wherein each sub-model includes a subset of ontological components selected from ontologies stored in the semantic data catalog, and wherein the ontological components includes at least one of classes, data properties, object properties, and individuals, and generates a unified intermediate graph structure as a preliminary context graph, wherein the extracted plurality of sub-models being preprocessed to filter duplicate entities and overlapping object properties across the sub-models using canonical entity alignment and ontology normalization rules. Then the system 115 identifies the missing linking entities and missing relationships from the ontologies to be embedded in the plurality of sub-models, wherein the missing linking entities and the missing relationships determined to be required for forming connected paths between the at least one entity and the at least one concept in the preliminary context graph.

Upon identifying the missing linking entities and missing relationships, the system 115 updates the preliminary context graph by embedding the identified missing linking entities and the missing relationships by traversing ontological graph structure to detect intermediate nodes and edges semantically connected to extracted entities based on a graph distance, a relationship strength, and a domain relevance. Then the system 115 performs a graph completeness checks to validate reachability of each of the at least one entity and the at least one concept from the user input within the updated preliminary context graph via ontologically valid object properties and filters semantically unrelated branches from the updated preliminary context graph based on a threshold semantic similarity score between each node and a user input embedding. Finally, the system 115 constructs a final context subgraph having semantically relevant entities, data properties, object properties, and linking paths representing a structure and relationships required to interpret the user input. The way in which the context is created is described in detail with reference to the context creation module 220 of FIG. 2.

Upon creating the context, the system 115 generates an executable query in a specific query language based on the context using the Large Language Model (LLM) 227, as shown at step 320. In an embodiment, the executable query is generated by processing the context and the user input within a structured prompt, wherein the context is represented in a query-language-specific schema format. To generate the query, the system 115 constructs a prompt by concatenating the received user input in natural language form, wherein the prompt includes a textual representation of the final context subgraph in the query-language-specific schema format, and a plurality of language-specific generation instructions. Then the system 115 converts the final context subgraph into the query-language-specific schema format and a plurality of candidate executable queries in the specified query language by processing the user input and a structured schema representation using the LLM 227. The way in which the queries are generated is described in detail with reference to the query generation module 225 of FIG. 2.

Upon generating the executable query, the system 115 validates the generated executable query, as shown at step 325. In an embodiment, the system validates the query using a multi-stage validation process, wherein the multi-stage validation process includes at least one of a syntax validation, a benign operation check, a grounding validation, and an execution validation. The syntax validation includes validation on the generated executable query by checking compliance with a formal grammar of a target query language using a syntax parser model. The benign operation check includes scanning the generated executable query for presence of potentially abnormal operations and rejecting queries having the potentially abnormal operations. The grounding validation includes mapping of tables, classes, columns, properties, and schema components present in the generated executable query with corresponding components in ontology-derived context subgraph and the execution validation includes executing the generated executable query in a staging environment to determine runtime errors. Upon validation, the system 115 generates one or more error messages corresponding to the generated executable query based on results of the syntax validation, the benign operation check, the grounding validation, and the execution validation, and regenerates the executable query by sending an updated prompt to the LLM 227, wherein the updated prompt includes the user input, prior invalid query, and the error message. The system 115 iteratively generates the executable query until a predefined maximum retry limit is reached.

Upon validation, the system 115 generates an LLM response for the received user input, as shown at step 330. In an embodiment, the response is generated based on results of the validation, wherein the response includes an explanation corresponding to the generated executable query and the generated executable query. Then the system 115 outputs the generated LLM response on a user interface of a user device 105.

In an embodiment, upon receiving the executable query, the system 115 generates a structured response which includes the validated executable query, and an explanation indicating a summary of operations being performed by the generated executable query, a mapping of each major clause in the generated executable query to a plurality of data entities, and a description of logical relationships between linked resources in the context subgraph. Further, the system 115 determines a description of the ontological relationships and schema elements formed on the basis of the context used for query generation. Then the system 115 generates a response for the received user input using the LLM 237 and based on the generated structured response and the determined description of the ontological relationships and the schema elements. That is, upon receiving the validated executable query, the system 115 generates a structured response (a machine-readable data object, for example, JSON) including the validated executable query, a summary of operation (a high-level explanation of what the query does), and class to entity mapping, and a description of the logical relationships in the context subgraph. Further, the system 115 analyzes the schema and context that were used to generate the query to determine ontological relationships between concepts/entities and schema elements. This provides semantic context to the query and ensures the LLM 237 understands the meaning behind data manipulations. Then the system 115 feeds the structured response (validated executable query and semantic breakdown) and the ontological description and schema elements to the LLM 237 which uses both to produce human-readable context aware response. The generate response is displayed on the interface of the user device 105. Hence, the system 115 generates executable queries over heterogenous data sources, validates the generated queries, extracts structural and ontological metadata from queries and data schemas, and uses these to generate natural language responses that are accurate, grounded, and semantically rich.

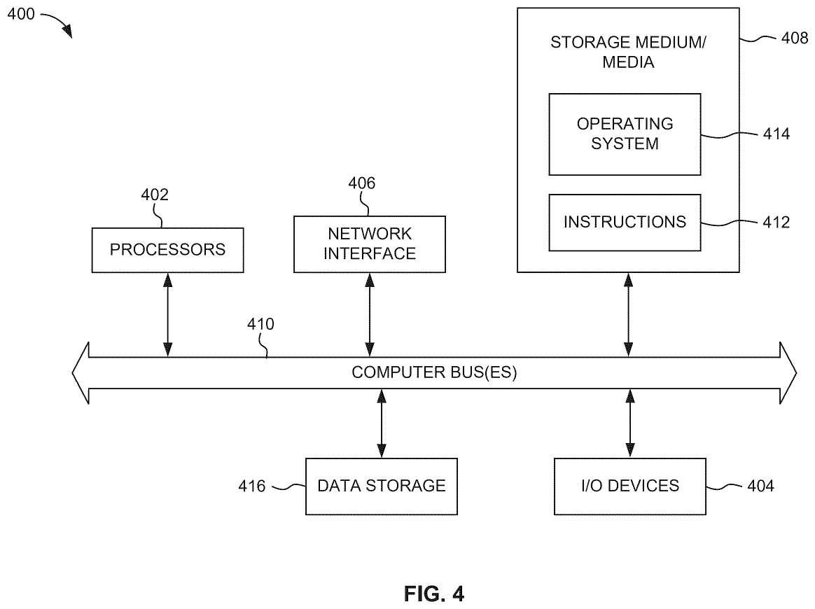

FIG. 4 illustrates a computer system that may be used to implement the system disclosed in the present disclosure. More particularly, computing machines such as desktops, laptops, and servers, which may be used to process the conversational interactions in the system 115 may have the structure of the computer system 400. The computer system 400 may include additional components not shown and that some of the process components described may be removed and/or modified. In another example, a computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, etc., a network interface 406, such as a Local Area Network (LAN), a wireless 902.11x LAN, a 3G or 4G mobile WAN or a WiMax WAN, and a processor-readable medium 408. Each of these components may be operatively coupled to a bus 410.

The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the methods and functions of the system 414.

The system 414 may be implemented as software stored on a non-transitory processor-readable medium and executed by the processors 402. For example, the computer-readable medium 408 may store an operating system 414, such as MAC OS, MS WINDOWS, UNIX, or LINUX, and code for the system 414. The operating system 414 may be multi-user, multiprocessing, multitasking, multithreading, real-time, and the like. For example, during runtime, the operating system 414 is running and the code for the system 414 is executed by the processor(s) 402.

The computer system 400 may include a data storage 416, which may include non-volatile data storage. The data storage 416 stores any data used or generated by the system 115. The network interface 406 connects the computer system 400 to internal systems for example, via a LAN. Also, the network interface 406 may connect the computer system 400 to the Internet. For example, the computer system 400 may connect to web browsers and other external applications and systems via the network interface 406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination with a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a user input corresponding to a user requirement from at least one user, wherein the user input comprises at least one entity and at least one concept corresponding to the user requirement;
extract a plurality of sub-models corresponding to the received user input based on a semantic similarity between the user input and a plurality of ontological representations of data sources stored in a semantic data catalog;
create a context of the received user input based on the extracted plurality of sub-models, wherein the context comprises a subgraph representing linked entities and relationships semantically related to the user input;
generate an executable query in a specific query language based on the context using a Large Language Model (LLM) by processing the context and the user input within a structured prompt, wherein the context is represented in a query-language-specific schema format;
validate the generated executable query using a multi-stage validation process, wherein the multi-stage validation process comprises at least one of a syntax validation, a benign operation check, a grounding validation, and an execution validation;
generate an LLM response for the received user input based on results of the validation, wherein the LLM response comprises an explanation corresponding to the generated executable query and the generated executable query; and
output the generated LLM response for the received user input on a user interface of a user device.

2. The system of claim 1, wherein the user input comprises named entities, domain-specific terms, and conceptual keywords.

3. The system of claim 1, wherein the processor is further to:
preprocess the user input using a natural language processing model, wherein the natural language processing model comprises a named entity recognition, a part-of-speech tagging, a dependency parsing, and a domain-specific concept mapping.

4. The system of claim 1, wherein to extract the plurality of sub-models corresponding to the received user input based on the semantic similarity between the user input and the plurality of ontological representations of data sources stored in the semantic data catalog, the processor is to:
encode preprocessed user input into a first vector embedding using a sentence and cross-encoder language model trained to generate contextualized semantic embeddings;
retrieve the plurality of ontological representations from the semantic data catalog, wherein each ontological representation corresponds to a type of data source of an organization and wherein each ontological representation being modeled as an ontology comprising classes, data properties, object properties, and individuals;
generate a plurality of vector embeddings for each ontological components within the plurality of ontological representations using a pretrained language model;
compute semantic similarity scores between the first vector embedding of the user input and each of the plurality of vector embeddings associated with the ontological components using a cosine similarity function;
rank the ontological components based on the computed semantic similarity scores;
select a set of subgraphs corresponding to the plurality of sub-models from the plurality of ontological representations by mapping the semantic similarity scores with a predefined threshold value;
identify additional linking entities and properties in the ontology components to be embedded in each sub-model; and
construct each sub-model as the subgraph of an ontology comprising the semantically similar ontological components and corresponding linking relationships.

5. The system of claim 1, wherein to create the context of the received user input based on the extracted plurality of sub-models, the processor is to:
aggregate the extracted plurality of sub-models, wherein each sub-model comprises a subset of ontological components selected from ontologies stored in the semantic data catalog, and wherein the ontological components comprise at least one of classes, data properties, object properties, and individuals;
generate a unified intermediate graph structure as a preliminary context graph, wherein the extracted plurality of sub-models being preprocessed to filter duplicate entities and overlapping object properties across the sub-models using canonical entity alignment and ontology normalization rules;
identify missing linking entities and missing relationships from the ontologies to be embedded in the plurality of sub-models, wherein the missing linking entities and the missing relationships determined to be required for forming connected paths between the at least one entity and the at least one concept in the preliminary context graph;
update the preliminary context graph by embedding the identified missing linking entities and the missing relationships by traversing ontological graph structure to detect intermediate nodes and edges semantically connected to extracted entities based on a graph distance, a relationship strength, and a domain relevance;
perform a graph completeness check to validate reachability of each of the at least one entity and the at least one concept from the user input within the updated preliminary context graph via ontologically valid object properties;
filter semantically unrelated branches from the updated preliminary context graph based on a threshold semantic similarity score between each node and a user input embedding; and
construct a final context subgraph comprising semantically relevant entities, data properties, object properties, and linking paths representing a structure and relationships required to interpret the user input.

6. The system of claim 1, wherein to generate the executable query in the specific query language based on the context using the Large Language Model (LLM) by processing the context and the user input within the structured prompt, the processor is to:
construct a prompt by concatenating the received user input in natural language form, wherein the prompt comprises a textual representation of the final context subgraph in the query-language-specific schema format, and a plurality of language-specific generation instructions;
convert the final context subgraph into the query-language-specific schema format; and
generate a plurality of candidate executable queries in the specified query language by processing the user input and a structured schema representation using the LLM.

7. The system of claim 1, wherein to validate the generated executable query using a multi-stage validation process comprising at least one of the syntax validation, the benign operation check, the grounding validation, and the execution validation, the processor is to:
perform the syntax validation on the generated executable query by checking compliance with a formal grammar of a target query language using a syntax parser model;
perform the benign operation check by scanning the generated executable query for presence of potentially abnormal operations, and reject queries comprising the potentially abnormal operations;
perform the grounding validation by mapping tables, classes, columns, properties, and schema components present in the generated executable query with corresponding components in ontology-derived context subgraph;
perform an execution validation by executing the generated executable query in a staging environment to determine runtime errors;
generate an error message specific corresponding to the generated executable query based on results of the syntax validation, the benign operation check, the grounding validation, and the execution validation;
regenerate the executable query by sending an updated prompt to the LLM, wherein the updated prompt comprises the user input, prior invalid query, and the error message; and
iteratively generate the executable query until a predefined maximum retry limit is reached.

8. The system of claim 1, wherein to generate the LLM response for the received user input based on the results of the validation, the processor is to:
generate a structured response upon successful validation of the executable query, wherein the structured response comprises the validated executable query, and an explanation indicating a summary of operations being performed by the generated executable query, a mapping of each major clause in the generated executable query to a plurality of data entities, and a description of logical relationships between linked resources in the context subgraph;
determine a description of the ontological relationships and schema elements formed on basis of the context used for query generation; and
generate the LLM response for the received user input based on the generated structured response and the determined description of the ontological relationships and the schema elements.

9. The system of claim 1, the processor is further to:
compute a semantic proximity score between the user input and entities within the context using a cross-encoder model trained on semantic similarity tasks;
compare the computed semantic proximity score to a predefined threshold;
update the plurality of sub-models with additional ontological entities semantically related to the user input; and
regenerate the executable query using the updated the plurality of sub-models.

10. The system of claim 1, wherein the processor is to:
receive a feedback on the results of validation from at least one data source, wherein the feedback comprises at least one of a syntax error message, a missing schema element, an invalid operation, and an execution failure message;
generate a structured error message comprising the received feedback and a reference to corresponding portion of previously generated query;
generate a revised prompt for the LLM based on the received feedback and the generated structured error message, wherein the revised prompt comprises the user input, the previously generated query, and the structured error message; and
re-generate a corrected executable query based on the generated revised prompt using the LLM.

11. A method comprising:
receiving, by a processor, a user input corresponding to a user requirement from at least one user, wherein the user input comprises at least one entity and at least one concept corresponding to the user requirement;
extracting, by the processor, a plurality of sub-models corresponding to the received user input based on a semantic similarity between the user input and a plurality of ontological representations of data sources stored in a semantic data catalog;
creating, by the processor, a context of the received user input based on the extracted plurality of sub-models, wherein the context comprises a subgraph representing linked entities and relationships semantically related to the user input;
generating, by the processor, an executable query in a specific query language based on the context using a Large Language Model (LLM) by processing the context and the user input within a structured prompt, wherein the context is represented in a query-language-specific schema format;
validating, by the processor, the generated executable query using a multi-stage validation process, wherein the multi-stage validation process comprises at least one of a syntax validation, a benign operation check, a grounding validation, and an execution validation;
generating, by the processor, an LLM response for the received user input based on results of the validation, wherein the LLM response comprises an explanation corresponding to the generated executable query and the generated executable query; and
outputting, by the processor, the generated LLM response on a user interface of a user device.

12. The method of claim 11, further comprising:
preprocessing, by the processor, the user input using a natural language processing model, wherein the natural language processing model comprises a named entity recognition, a part-of-speech tagging, a dependency parsing, and a domain-specific concept mapping.

13. The method of claim 11, wherein extracting the plurality of sub-models corresponding to the received user input based on the semantic similarity between the user input and the plurality of ontological representations of data sources stored in the semantic data catalog comprises:
encoding, by the processor, preprocessed user input into a first vector embedding using a sentence and cross-encoder language model trained to generate contextualized semantic embeddings;
retrieving, by the processor, the plurality of ontological representations from the semantic data catalog, wherein each ontological representation corresponds to a type of data source of an organization and wherein each ontological representation being modeled as an ontology comprising classes, data properties, object properties, and individuals;
generating, by the processor, a plurality of vector embeddings for each ontological components within the plurality of ontological representations using a pretrained language model;
computing, by the processor, semantic similarity scores between the first vector embedding of the user input and each of the plurality of vector embeddings associated with the ontological components using a cosine similarity function;
ranking, by the processor, the ontological components based on the computed semantic similarity scores;
selecting, by the processor, a set of subgraphs corresponding to the plurality of sub-models from the plurality of ontological representations by mapping the semantic similarity scores with a predefined threshold value;
identifying, by the processor, additional linking entities and properties in the ontology components to be embedded in each sub-model; and
constructing, by the processor, each sub-model as the subgraph of an ontology comprising the semantically similar ontological components and corresponding linking relationships.

14. The method of claim 11, wherein creating the context of the received user input based on the extracted plurality of sub-models comprises:
aggregating, by the processor, the extracted plurality of sub-models, wherein each sub-model comprises a subset of ontological components selected from ontologies stored in the semantic data catalog, and wherein the ontological components comprise at least one of classes, data properties, object properties, and individuals;
generating, by the processor, a unified intermediate graph structure as a preliminary context graph, wherein the extracted plurality of sub-models being preprocessed to filter duplicate entities and overlapping object properties across the sub-models using canonical entity alignment and ontology normalization rules;
identifying, by the processor, missing linking entities and missing relationships from the ontologies to be embedded in the plurality of sub-models, wherein the missing linking entities and the missing relationships determined to be required for forming connected paths between the at least one entity and the at least one concept in the preliminary context graph;
updating, by the processor, the preliminary context graph by embedding the identified missing linking entities and the missing relationships by traversing ontological graph structure to detect intermediate nodes and edges semantically connected to extracted entities based on a graph distance, a relationship strength, and a domain relevance;
performing, by the processor, a graph completeness checks to validate reachability of each of the at least one entity and the at least one concept from the user input within the updated preliminary context graph via ontologically valid object properties;
filtering, by the processor, semantically unrelated branches from the updated preliminary context graph based on a threshold semantic similarity score between each node and a user input embedding; and
constructing, by the processor, a final context subgraph comprising semantically relevant entities, data properties, object properties, and linking paths representing a structure and relationships required to interpret the user input.

15. The method of claim 11, wherein generating the executable query in the specific query language based on the context using the Large Language Model (LLM) by processing the context and the user input within the structured prompt comprises:
constructing, by the processor, a prompt by concatenating the received user input in natural language form, wherein the prompt comprises a textual representation of the final context subgraph in the query-language-specific schema format, and a plurality of language-specific generation instructions;
converting, by the processor, the final context subgraph into the query-language-specific schema format; and
generating, by the processor, a plurality of candidate executable queries in the specified query language by processing the user input and a structured schema representation using the LLM.

16. The method of claim 11, wherein validating the generated executable query using the multi-stage validation process comprising at least one of the syntax validation, the benign operation check, the grounding validation, and the execution validation comprises:
performing, by the processor, the syntax validation on the generated executable query by checking compliance with a formal grammar of a target query language using a syntax parser model;
performing, by the processor, the benign operation check by scanning the generated executable query for presence of potentially abnormal operations, and reject queries comprising the potentially abnormal operations;
performing, by the processor, the grounding validation by mapping tables, classes, columns, properties, and schema components present in the generated executable query with corresponding components in ontology-derived context subgraph;
performing, by the processor, an execution validation by executing the generated executable query in a staging environment to determine runtime errors;
generating, by the processor, an error message corresponding to the generated executable query based on results of the syntax validation, the benign operation check, the grounding validation, and the execution validation;
regenerating, by the processor, the executable query by sending an updated prompt to the LLM, wherein the updated prompt comprises the user input, prior invalid query, and the error message; and
iteratively generating, by the processor, the executable query until a predefined maximum retry limit is reached.

17. The method of claim 11, wherein generating the LLM response for the received user input based on the results of the validation comprises:
generating, by the processor, a structured response upon successful validation of the executable query, wherein the structured response comprises the validated executable query, and an explanation indicating a summary of operations being performed by the generated executable query, a mapping of each major clause in the generated executable query to a plurality of data entities, and a description of logical relationships between linked resources in the context subgraph;
determining, by the processor, a description of the ontological relationships and schema elements formed on basis of the context used for query generation; and
generating, by the processor, the LLM response for the received user input based on the generated structured response and the determined description of the ontological relationships and the schema elements.

18. The method of claim 11, further comprising:
computing, by the processor, a semantic proximity score between the user input and entities within the context using a cross-encoder model trained on semantic similarity tasks;
comparing, by the processor, the computed semantic proximity score to a predefined threshold;
updating, by the processor, the plurality of sub-models with additional ontological entities semantically related to the user input; and
regenerating, by the processor, the executable query using the updated the plurality of sub-models.

19. The method of claim 11, further comprising:
receiving, by the processor, a feedback on the results of validation from at least one data source, wherein the feedback comprises at least one of a syntax error message, a missing schema element, an invalid operation, and an execution failure message;
generating, by the processor, a structured error message comprising the received feedback and a reference to corresponding portion of previously generated query;
generating, by the processor, a revised prompt for the LLM based on the received feedback and the generated structured error message, wherein the revised prompt comprises the user input, the previously generated query, and the structured error message; and
re-generating, by the processor, a corrected executable query based on the generated revised prompt using the LLM.

20. A non-transitory computer readable medium comprising a processor-executable instructions that cause a processor to:
receive a user input corresponding to a user requirement from at least one user, wherein the user input comprises at least one entity and at least one concept corresponding to the user requirement;
extract a plurality of sub-models corresponding to the received user input based on a semantic similarity between the user input and a plurality of ontological representations of data sources stored in a semantic data catalog;
create a context of the received user input based on the extracted plurality of sub-models, wherein the context comprises a subgraph representing linked entities and relationships semantically related to the user input;
generate an executable query in a specific query language based on the context using a Large Language Model (LLM) by processing the context and the user input within a structured prompt, wherein the context is represented in a query-language-specific schema format;
validate the generated executable query using a multi-stage validation process, wherein the multi-stage validation process comprises at least one of a syntax validation, a benign operation check, a grounding validation, and an execution validation;
generate an LLM response for the received user input based on results of the validation, wherein the LLM response comprises an explanation corresponding to the generated executable query and the generated executable query; and
output the generated LLM response on a user interface of a user device.
